(19) United States
(12) Patent Application Publication
(10) Pub. No.: US 2008/0210407 A1
(43) Pub. Date: Sep. 4, 2008

(54) Heat Transfer Device and Manufacturing Method Thereof Using Hydrophilic Wick

(75) Inventors: Jong Jin Kim, Seoul (KR); Sung Wook Jang, Seoul (KR); Jong Soo Lim, Seoul (KR); Young Gil An, Seoul (KR); Jeong Hyun Lee, Gyeonggi-do (KR); Jae Joon Choi, Gyeonggi-do (KR)

Correspondence Address: HYUN JONG PARK, 41 WHITE BIRCH ROAD, REDDING, CT, 06896-2209, US

(73) Assignee: Celsia Technologies Korea Inc., Seoul (KR)

(21) Appl. No.: 11/813,423

(22) PCT Filed: Jan. 5, 2006
(86) PCT No.: PCT/KR06/00037

§ 371 Date: Dec. 3, 2007

(30) Foreign Application Priority Data
Jan. 6, 2005 (KR) 10-2005-0001028

(51) Int. Cl. F28D 15/02; B23P 15/26

(52) U.S. Cl. 165/104.26; 29/890.039

(57) ABSTRACT

Provided is a flat panel type heat transfer device for effectively dissipating heat generated from a heat source in contact with a casing, comprising the casing sealed and having a certain shape, a coolant loaded in the casing and undergoing phase transition, one or more flat panel type hydrophilic wick structures in contact with at least a portion of an inner surface of the casing, manufactured by aggregating fibers capable of absorbing the coolant, and providing a coolant passage leading the coolant to flow in a direction parallel to the inner surface of the casing, and one or more support structures, each having a plurality of through holes which provide coolant passages through which coolant in a vapor phase or a liquid phase flows, while supporting the hydrophilic wick structure such that the hydrophilic wick structure is in close contact with the inner surface of the casing, wherein the coolant fills a portion of a space in the casing and circulates in the space in a manner such that the coolant flows through the hydrophilic wick structure by means of capillary force generated in fine passages formed in the hydrophilic wick structure toward a relatively hot point, is evaporated by heat from a heat source, flows in a vapor phase toward a relatively low temperature point, condenses at the relatively low temperature point, flows back in a liquid phase to the relatively hot point, and repeats the cycle of evaporation and condensation.

### REFERENCE TO RELATED APPLICATIONS

This is a continuation of pending International Patent Application PCT/KR2006/000037 filed on Jan. 5, 2006, which designates the United States and claims priority of Korean Patent Application No. 10-2005-0001028 filed on Jan. 6, 2005.

### FIELD OF THE INVENTION

The present invention relates to a heat transfer device and a method of manufacturing the same. More particularly, the present invention relates to a heat transfer device for cooling a heat source by transferring heat from the heat source, such as electric components, semiconductor chips and display devices, to a relatively low temperature point.

### BACKGROUND OF THE INVENTION

Recently, as the degree of integration of semiconductor chips, such as central processing units (CPU) and embedded chips, increases, cooling the semiconductor chips becomes a more important problem to solve. Further, electronic components, such as notebook computers, personal digital assistants (PDAs), and cellular phones, are getting slimmer and lighter, and cooling technologies for cooling panels of liquid crystal displays (LCD) and luminescent diodes (LED) are attracting a lot of attention. However, known methods for cooling semiconductor chips, etc. mounted in the electronic components have the technical limits from structural and functional points of view, in particular from the aspects of packaging and cooling fan technologies.

Breaking through the technical limits, a micro-structure called a heat pipe has emerged and is attracting strong attention as a promising heat transfer device for cooling semiconductor chips.

FIG. 1a and 1b illustrate a flexible heat pipe according to the first prior art, disclosed in U.S. Pat. No. 6,446,706. The flexible heat pipe includes a sealed outer casing 26 comprising a polypropylene layer 28, a first metal foil layer 32 attached to the polypropylene layer 28 by a first adhesive layer 30, a second metal foil layer 12 attached to the first metal foil layer 32 by a second adhesive layer 34, and a wick layer 24 which is formed using a flexible and porous material. The heat pipe further includes a separation layer 18 which supports the wick layer 24 such that the wick layer 24 stays in close contact with the outer casing 26 and allows vapor to flow in many directions in the casing. The separation layer 18 is realized as a mesh screen made of polypropylene. The wick layer 24 is made of a copper felt material. The copper felt comprises micro-fibers, each having a diameter of 20 micro inches and a length of 0.2 inches, and copper powder filled in the wick structure in an amount of 20 to 60% of the total volume of the wick structure (Refer to col. 3, lines 17 to 21).

FIG. 2 illustrates a flat panel type heat transfer device according to the second prior art disclosed in Korean Patent Laid-Open Publication Number 10-2004-18107. The heat transfer device comprises an upper plate 200, and a lower plate 100 disposed under the upper plate 200, having a gap between the upper plate 200 and the lower plate 100, in which the lower surface of the lower plate 100 corresponds to an evaporation part P1 and is in contact with a heat source. The heat transfer device further comprises wick plates 120 disposed so as to be in close contact with the upper surface of the lower plate 100 due to the surface tension of liquid coolant, and a spacer plate 110 for maintaining the distance between the lower plate 100 and the wick plate 120.

The liquid coolant circulates between the evaporation part P1 and a condensation part P2. That is, the liquid phase coolant continuously flows to the evaporation part P1 by means of capillary force generated between it and the lower plate, enters a vapor phase at the evaporation part P1, flows in a vapor phase toward the condensation part P2, and condenses at the condensation part P2. The spacer plate 110 serves to maintain the distance between the lower plate 100 and the wick plate 120 by using the surface tension generated between of them.

The heat pipe disclosed in the first prior art has the following disadvantages. First, manufacturing the heat pipe is difficult and complex because the heat pipe has a complex inner structure. Second, since the wick layer 24 is copper felt, the degree of contact between the inner surfaces of the outer casing and the wick layer 24 varies among locations of the wick layer 24, and fine passages formed in the wick layer 24, for generating capillary force, are irregular, so that the reproducibility of the heat transfer device is poor with respect to heat conductivity. Third, since it is difficult to manufacture the copper felt to be thin, the wick layer is thick, so that the heat pipe is thick too. Due to this problem, the heat pipe cannot be used as a heat transfer device for ultra-thin semiconductor devices.

Fourth, since the flow resistance is high, it is difficult to generate high capillary force. Accordingly, the fine passages for generating capillary force are irregular. Accordingly, when the coolant actively evaporates around a heat source, the flow of the vapor phase coolant may be cut off.

The flat panel type heat transfer device according to the second prior art has the following disadvantages. First, it is not easy to manufacture the flat panel type heat transfer device, and mass production thereof is impossible because micro machining is needed to manufacture a thin and complex structure to be inserted between an upper plate and a lower plate. Accordingly, due to these structural limits, the flat panel type heat transfer device can be manufactured no thinner than several millimeters thick.

The flat panel type heat transfer device according to the second prior art is structured such that liquid coolant flows in gaps formed between planar wicks provided in the wick plate 120, or gaps formed between the wick plate 120 and the lower plate. Accordingly, the device needs micro structures, such as bridges, for connecting protrusions formed on the lower plate and the upper plate or connecting planar wicks, in order to form uniform gaps. However, it is difficult to precisely machine such micro structures, since the micro structures are so complex and are several millimeters thick, so that the micro structures can be mounted in the flat panel type heat transfer device. In particular, mass production of such micro structures is more difficult since the structure is so much complex, thereby the machining process therefor is very difficult and machining errors can occur. Nonuniform gaps caused by the machining errors result in drying out of the liquid phase coolant at the evaporation part, thereby causing fatal failure of the heat transfer device.

FIG. 3 illustrates a flat panel type heat transfer device according to the third prior art disclosed in Korean Patent Application No. 10-2004-91617 which was invented and filed by the present applicant. The heat transfer device shown in FIG. 3 comprises an upper metal plate 300, a lower metal plate 350, a pressuring support structure 310, and a plurality of thin plates 320 and 322, the pressuring support structure 310 and the thin plates 320 and 322 being interposed between the upper plate 300 and the lower plate 350. Each of the thin plates has through patterns that are parallel to each other, formed by a micromachining process such as an etching or a punching process. The pressuring support structure 310 is made of a porous material such as a mesh screen having through holes dense enough so that vapor, generated by the vaporization of coolant, occurring because the heat source is in contact with the lower surface of the lower plate 350, can move in a vertical direction.

The pressuring support structure 310 presses at least a portion of the parallel patterns of the thin plates 320 and 322 when assembled. Thanks to the pressure from the pressuring support plate 310, the parallel patterns of the thin plates 320 and 322 are brought into in close contact with the upper surface of the lower plate 350, so that micro gaps, smaller than those of the patterns in an initial state, are formed. Accordingly, it is possible to break through the process limit of etching or machining when forming micro patterns on the flat plates, and it is possible to realize fine coolant passage having a diameter of several micro meters, which is difficult to realize by the processing method such as etching or machining.

However, the heat transfer device according to the third prior art has the following disadvantage. That is, as shown in FIGS. 4a and 4b, since the thin metal plate or the screen mesh having parallel fine patterns, used for providing fine passages for the liquid phase coolant, is not made of a material that can absorb water, in the case that the fine passages have manufacturing errors or are not quite precisely manufactured, the fine passages can dry out. Further, because the thickness of the electronic device is reduced, the electronic device can be applied to many fields, but it requires that the thickness of the thin metal plates having fine patterns also be reduced. However, such an extremely thin metal plate is difficult to handle and incurs high processing cost. Accordingly, the manufacturing cost increases.

### SUMMARY OF THE INVENTION

Accordingly, the present invention is devised in consideration of the aforementioned problems and situations, and it is an object of the present invention to provide a heat transfer device having a new flat panel structure and ensuring high thermal conductivity at low cost, and a method of manufacturing the same.

It is a further object of the present invention to provide a heat transfer device having a flat panel structure, in which inner components in the device are made of a material having the capability to absorb water, thereby being able to eliminate the possibility of drying-out, and a method of manufacturing the same.

It is a still further object of the present invention to provide a heat transfer device having a flat panel structure, such that the heat transfer device can be manufactured by a simple method at low cost, and at high productivity since the defective proportion is low when the heat transfer devices are manufactured at mass production volumes. Further provided is a method for manufacturing the same heat transfer device.

It is a yet further object of the present invention to provide a heat transfer device having a flat panel structure and having a high coolant supply capacity by means of high capillary force, and having high reliability because the device is little affected by processing errors, and a method for manufacturing the same.

In order to achieve the above objects, according to one aspect of the present invention, there is provided a flat panel type heat transfer device for effectively dissipating heat generated from a heat source that is in contact with a casing, comprising (a) the sealed casing having a certain shape, (b) coolant charged in the casing and undergoing phase transition, (c) one or more flat panel type hydrophilic wick structures in contact with at least a portion of an inner surface of the casing, and manufactured by aggregating fibers capable of absorbing the coolant, and providing a coolant passage leading the coolant to flow in a direction parallel to the inner surface of the casing, and (d) one or more support structures, each having a plurality of through holes which provide coolant passages through which vapor or liquid phase coolant flows, while supporting the hydrophilic wick structure such that the hydrophilic wick structure is in close contact with the inner surface of the casing, wherein the coolant fills a portion of a space in the casing and circulates in the space in such a manner that the coolant flows in the liquid phase through the hydrophilic wick structure by means of capillary force generated in fine passages formed in the hydrophilic wick structure toward a relatively hot point, is evaporated by heat from a heat source at the hot point, flows in the vapor phase towards a relatively low temperature point, condenses at the relatively low temperature point, flows back to the hot point in the liquid phase again, and repeats the cycle of evaporation and condensation.

The casing comprises an upper plate and a lower plate, a support structure in contact with an inner surface of the upper plate, and hydrophilic wick structures interposed between the upper plate and the lower plate.

The flat panel type heat transfer device further comprises one or more hydrophilic wick structures disposed between the upper plate and the support structure, and in contact with an inner surface of the upper plate.

The molecular structure of the fiber includes one or more hydrophilic groups selected from the group consisting of —OH, —COOH, ═O, —NH2, —NH— and ═N—, the hydrophilic group being capable of easily bonding to water, or the fiber is chemically treated to have a hydrophilic characteristic on the surface thereof, thereby having the capability to absorb water. Alternatively, the fiber has a non-circular sectional shape, thereby having the capability to store water therein. The fiber may have one or more hollows in its section, thereby having the capability to hold water in the hollows. The fiber can have fine scratches or grooves on the surface thereof, or the surface of the fiber can be treated to have roughness. The fiber is a natural fiber, a synthetic fiber, an inorganic fiber or a carbon nanotube.

The hydrophilic wick structure is able to absorb water in an amount of 0.5 times the weight thereof. The hydrophilic wick structure provides capillary force that can move coolant via micro channels formed between the fibers. The fiber has the diameter of 1.0 millimeters or less, and the hydrophilic wick structure has a thickness of 5.0 millimeters or less.

The support structure is a porous structure having vertical through holes and horizontal through holes in order to enable the vapor phase coolant to move in a vertical direction and the liquid phase coolant to move in a horizontal direction. The support structure serves as a thermal insulator for thermally insulating a liquid phase coolant passage, formed by the micro channels in the hydrophilic wick structure disposed under the support structure, from a vapor phase coolant passage disposed above the support structure. Each of the vertical through holes serving as the vapor phase coolant passage has a diameter from 0.5 to 4 millimeters, each of the horizontal through holes serving as a liquid phase coolant passage has a diameter from 10 to 300 micrometers, and the support structure has a thickness of 1 millimeter or less.

The support structure has an embossed pattern on a flat plate, the embossed pattern having a trapezoidal shape and a through hole formed to pass through a cross section of the trapezoidal embossed pattern.

The support structure is a screen mesh having a mesh number of 50 or less based on E-11-95 of the ASTM standard. The screen mesh is made of metal, polymer, silicon or ceramic.

The casing comprises an upper plate and a lower plate, both plates being made of metal, polymer, silicon or nonferrous metal, or being coated with polymer.

The casing can have a plurality of grooves serving as coolant passages on an inner surface thereof.

The flat panel type heat transfer device has a thickness of 10.0 millimeters or less.

The casing is made of a flexible polymer, and the heat transfer device further comprises a thin plate disposed between the support structure and the inner surface of the casing in order to prevent the inner surface of the casing from blocking an entrance of a through hole of the support structure.

The flat panel type heat transfer device may further comprise a thin plate disposed between the hydrophilic wick structure and the inner surface of the casing, in order to prevent the hydrophilic wick structure from blocking the entrance of the through hole of the support structure when air in the casing is discharged.

According to another aspect of the present invention, there is provided a flat panel type heat transfer device for effectively dissipating heat generated from a heat source being in contact with the outer surface of a casing, comprising a sealed casing having a predetermined shape, coolant injected in the casing and undergoing phase transition, one or more hydrophilic wick structures in contact with a portion of an inner surface of the casing, manufactured by aggregating fibers, in which the fiber has a structure able to absorb the coolant in itself, and providing a coolant passage parallel to the inner surface of the casing, and a plurality of protrusions formed on the inner surface of the casing in order to provide support such that the hydrophilic wick structure is in contact with the opposite inner surface of the casing, and in order to provide a liquid phase coolant passage and a vapor phase coolant passage between them, wherein the coolant fills a portion of a space in the casing, flows through the hydrophilic wick structure by means of capillary force generated in fine channels in the hydrophilic wick structure, and circulates in the space in a manner such that the coolant is evaporated by a heat source, changes into a vapor phase, condenses at a relatively low temperature point and changes into a liquid phase, thereby performing heat transfer.

The protrusions are formed by means of etching or mechanical machining of the inner surface of the casing.

The protrusion has a cylinder shape or a polygonal pillar shape, and the distance between the protrusions is from about 0.2 to about 20 millimeters.

According to a further aspect of the present invention, there is provided a chip set comprising a flat panel type heat transfer device having the above-mentioned characteristics and one or more semiconductor chips in contact with the flat panel type heat transfer device.

According to a still further aspect of the present invention, there is provided a method of manufacturing a heat transfer device, comprising the steps of aligning a hydrophilic wick structure containing coolant therein on a lower plate, aligning a support structure on the hydrophilic wick structure, combining an upper plate and the lower plate such that the hydrophilic wick structure is in close contact with the lower plate due to the support structure, discharging air to reduce the pressure in the space between the upper plate and the lower plate, and sealing the space between the upper plate and the lower plate.

### BRIEF DESCRIPTION OF THE DRAWINGS

FIGS. 1a and 1b are a flexible heat pipe disclosed in the first prior art, U.S. Pat. No. 6,446,706;

FIG. 2 is a flat panel type heat transfer device disclosed in the second prior art, Korean Patent Laid-Open Publication Number 10-2004-18107;

FIG. 3 is a flat panel type heat transfer device disclosed in the third prior art, Korean Patent Application Number 10-2004-91617;

FIGS. 4a and 4b is the result of tests of the moisture absorption and holding characteristics of a thin plate 320 having parallel fine patterns and a dense mesh 324, according to one conventional art;

FIGS. 5a and 5b are the result of tests of the moisture absorption and holding characteristics of the hydrophilic wick structure according to the present invention;

FIG. 6 is a perspective view illustrating a heat transfer device having a flat panel structure according to a first embodiment of the present invention;

FIG. 7 is a cross-sectional view illustrating the heat transfer device shown in FIG. 6;

FIG. 8 is a cross-sectional view illustrating a portion of the heat transfer device having a flat panel structure and hydrophilic wicks, according to a second embodiment of the present invention;

FIGS. 9a and 9g illustrate many types of fibers that can adsorb and hold moisture therein;

FIG. 10 is a sectional view illustrating a fiber that can adsorb and hold moisture;

FIGS. 11a and 11b illustrate fibers having surfaces on which micro channels or fine grooves are formed;

FIGS. 12a and 12b is the results of tests of comparison coolant absorptivity among a conventional mesh screen wick, a conventional thin plate wick having micro channels, and a hydrophilic wick according to the present invention;

FIG. 13 is an enlarged view illustrating a hydrophilic wick structure according to the present invention;

FIGS. 14a and 14b are the results of tests of performance of the heat transfer device having the hydrophilic wick structure according to the present invention;

FIGS. 15a to 15f are examples of the support structure used in the heat transfer device according to the present invention;

FIG. 16 is an exploded perspective view illustrating a heat transfer device according to a fourth embodiment of the present invention;

FIGS. 17a and 17b are sectional views illustrating the heat transfer device according to a fifth embodiment of the present invention;

FIG. 18 is a flow chart showing a method of manufacturing the conventional flat panel type heat transfer device shown in FIG. 3; and

FIG. 19 is a flow chart showing a method of manufacturing a flat panel type heat transfer device according to the present invention.

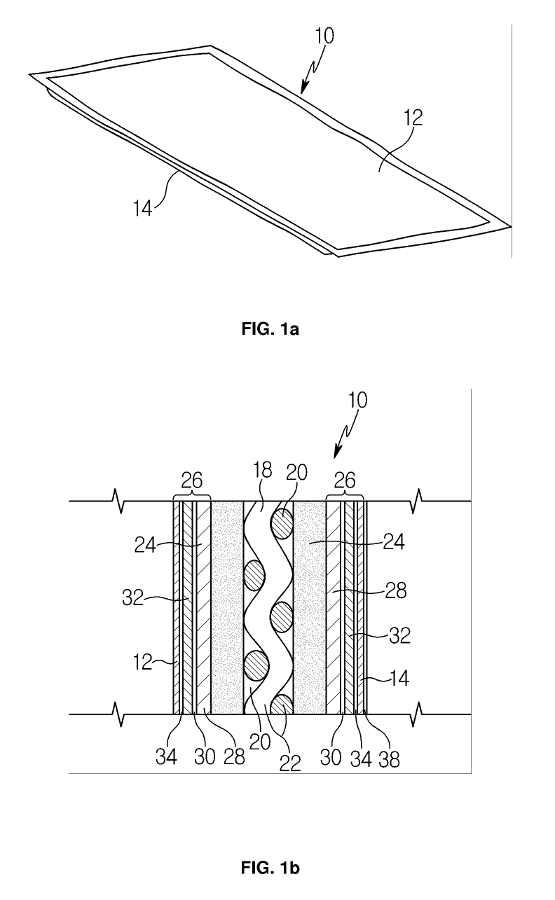

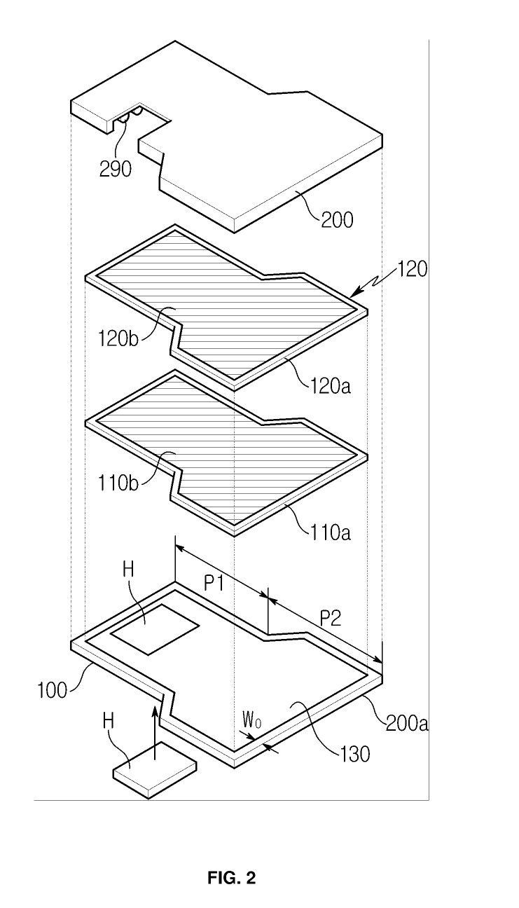

### DETAILED DESCRIPTION OF THE INVENTION

Hereinafter, heat transfer devices according to embodiments of the present invention will be described with reference to the accompanying drawings.

The term “hydrophilic wick” is defined as a structure made of a material having a characteristic of being capable of absorbing and holding coolant such as water, and is an aggregation of fine fibers. That is, each of the fine fibers has the capability to absorb and hold water therein.

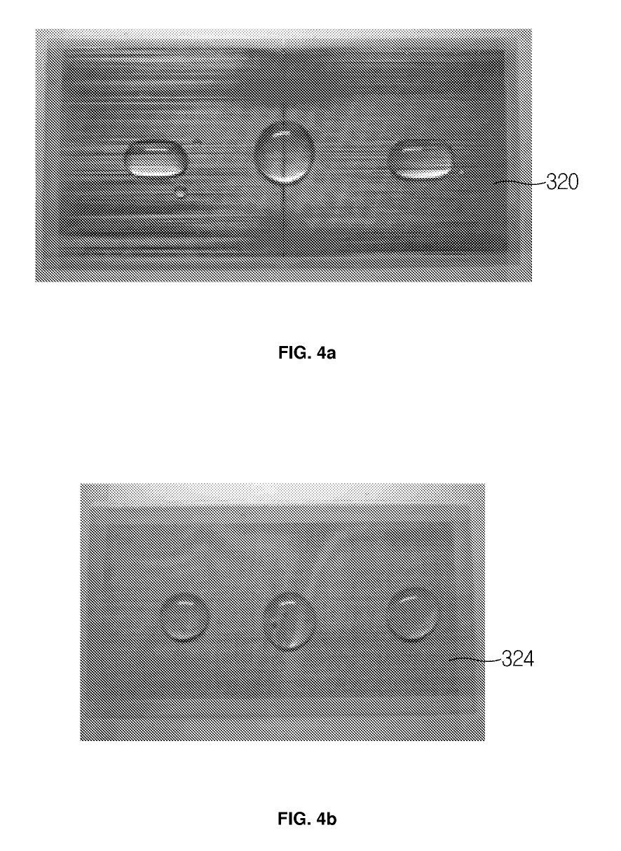

FIGS. 4a and 4b show the results of comparison of water absorption and water holding abilities of a thin plate 320 and a dense mesh screen 324. As illustrated in FIGS. 4a and 4b, the conventional thin plate 320 and the mesh screen 324 have the characteristics such that almost no moisture permeates into through holes or micro channels thereof. In order to achieve better wettability and better water holding capability, the surfaces of the thin plate 320 and the mesh screen 324 should be treated more to be endowed with the hydrophilic characteristics. However, even if the thin plate 320 and the mesh screen 324 undergo the hydrophilic treatment, there is just slight improvement in wettability and the capability to hold water. Further, if the device is not assembled and placed in a lower pressure state right after the hydrophilic treatment, the surface of the device is oxidized, so that the device returns to its initial state as shown in FIGS. 4a and 4b.

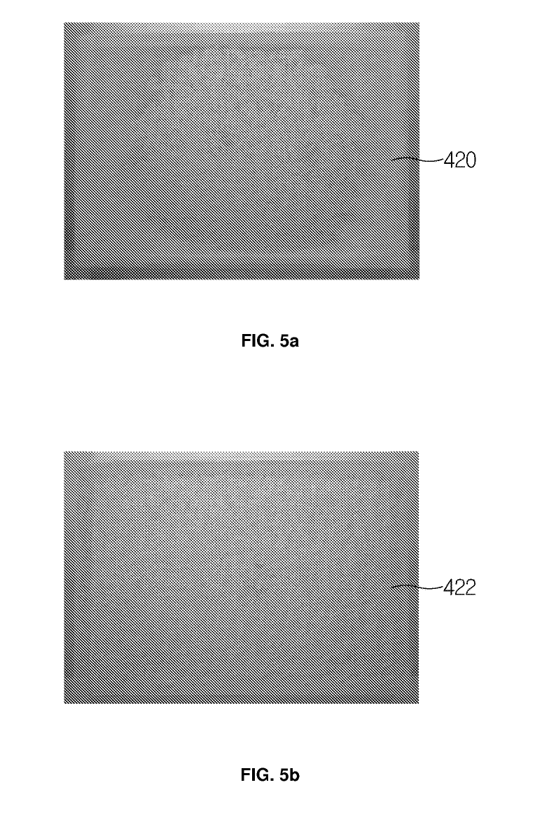

However, in the case of using a hydrophilic wick structure according to the present invention as shown in FIGS. 5a and 5b, since the structure has a water absorbing and holding characteristic in itself, coolant such as water can permeate into the structure in a short time, and can remain in the structure.

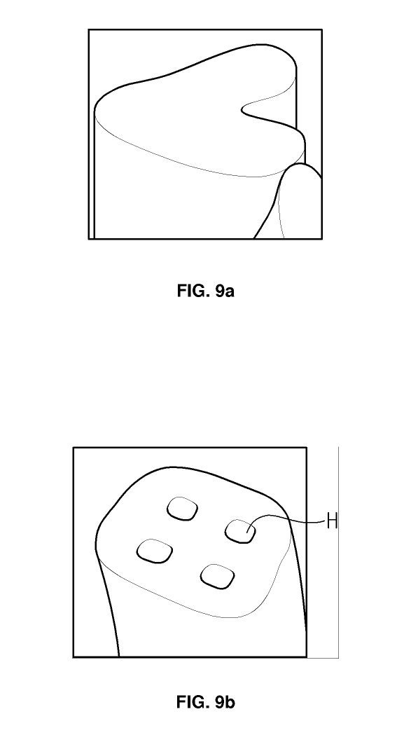

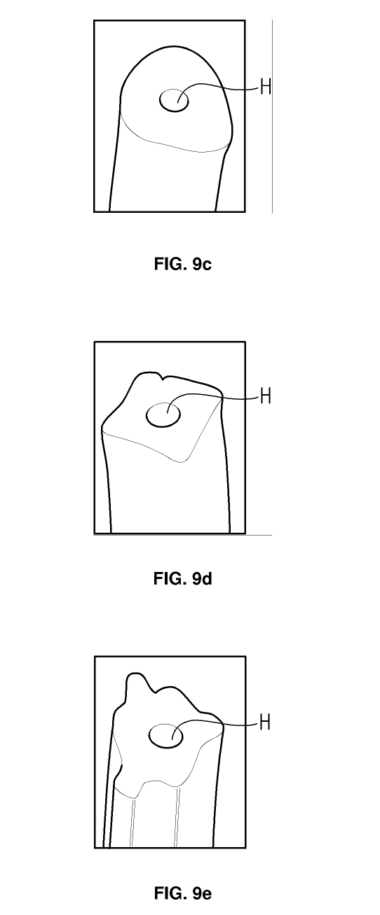

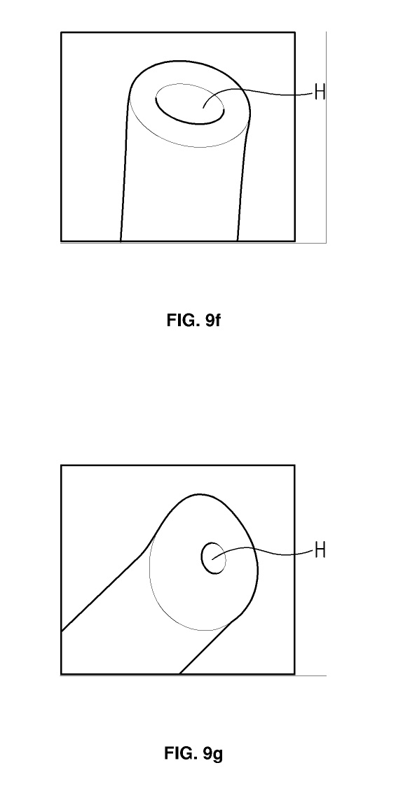

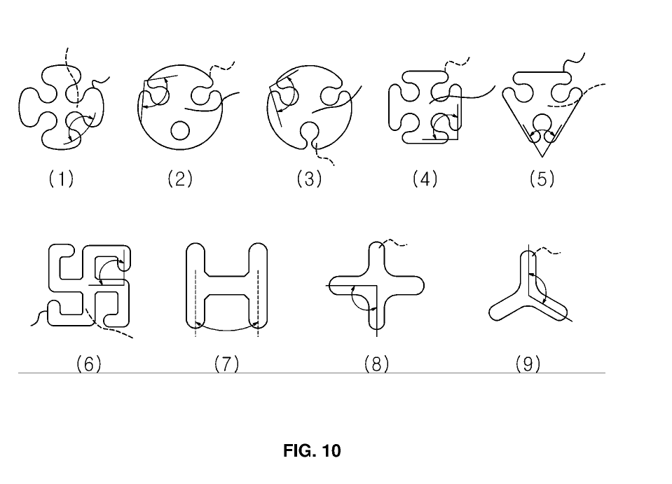

The fiber of the hydrophilic wick structure has hydrophilic groups such as —OH, —COOH, ═O, —NH2, —NH—, ═N—, etc. on the surface thereof, so that it can easily bond to water at the molecular level. Alternatively, as shown in FIGS. 9a to 9g, since the fiber has a hollow H herein, water can be absorbed into the fiber through the hollow H by capillary force and can be held in the fiber. As shown in FIG. 10, the fiber can have a section which is not circular.

For example, as shown in FIG. 10, fibers having a variety of shapes are made of absorptive polyester filament, and have physical characteristics corresponding to the structures, examples 1 to 9, as shown in table 1.

TABLE 1
Physical characteristics according to the structures of fibers.

| | Structure of the section | | Physical characteristics | |
|---|---|---|---|---|
| Type of section | R value | θ (angle) | Absorptivity | Moisture rate |
| Circular | 14 | — | 0.6 | 37 |
| 1 | 220 | −145 | 2.2 | 95 |
| 2 | 80 | −180 | 2.4 | 88 |
| 3 | 85 | −90 | 2.3 | 92 |
| 4 | 250 | −90 | 2.2 | 96 |
| 5 | — | — | — | — |
| 6 | 170 | −90 | 2.2 | 90 |
| 7 | 120 | 0 | 0.6 | 78 |
| 8 | — | — | — | — |
| 9 | 65 | 120 | 0.6 | 50 |

Here, R is an index defined as an expression of R=(Circumferential length of a section of a fiber)²/Area of a section of a fiber.

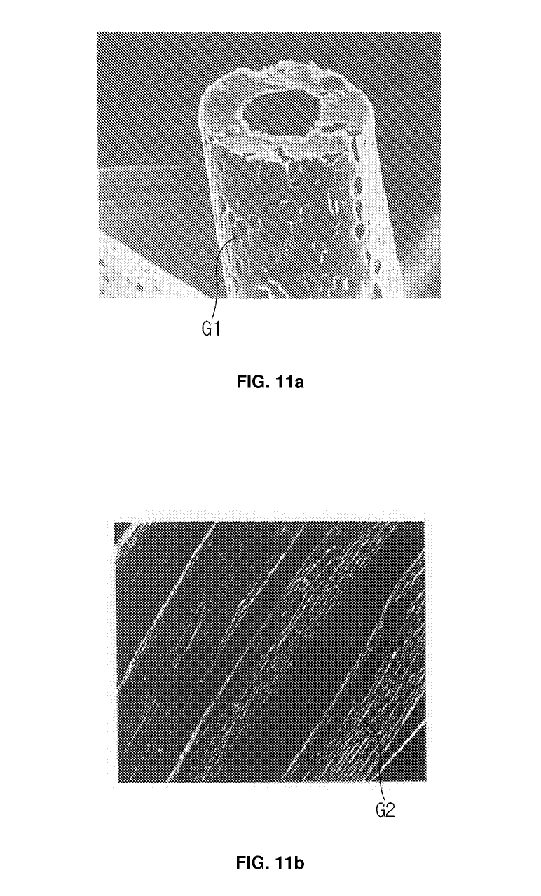

As shown in FIG. 11a and FIG. 11b, the fiber constituting the hydrophilic wick used in the heat transfer device according to the present invention has channels or fine grooves on the surface thereof, so that it has a high capability to absorb and hold water.

In addition, carbon nanotubes having application fields which have recently become wider as the hydrophilic wick for the heat transfer device according to the present invention, since carbon nanotubes have a large surface area, enough pores and light weight, thereby being capable of holding much more water.

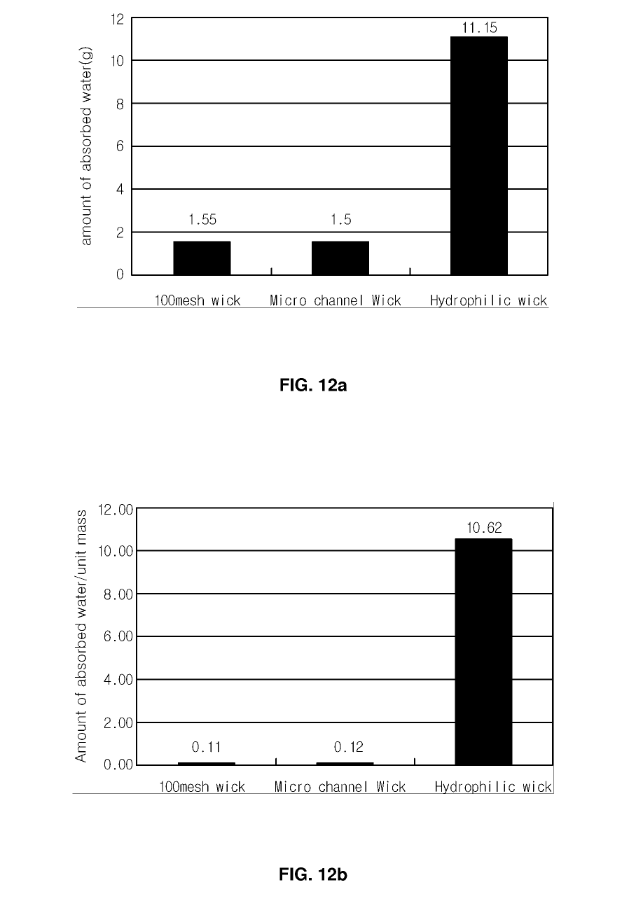

FIGS. 12a and 12b show the results of comparison of the coolant absorption abilities of the conventional thin plate wick having micro channels, the conventional mesh screen wick and the hydrophilic wick for use in the heat transfer device according to the present invention. Referring to FIG. 12a, the hydrophilic wick according to the present invention has the water absorption capability remarkably greater than that of the conventional mesh screen wick and the conventional thin plate wick having micro channels. Referring to FIG. 12b, it is found that the hydrophilic wick has excellent water absorption capability in an aspect of the amount of absorbed water per unit mass. The heat transfer device manufactured using the hydrophilic wick, according to the present invention, has the advantages of being capable of supplying enough coolant for the amount of heat radiated from a heat source, without causing dry-out of the coolant, and being capable of solving the dry-out problem which is caused due to the gravity gradient. Further, since the wick structure can absorb enough coolant even in the case where the wick structure is thin, the heat transfer device can be realized to have a thin structure. In addition, since the wick structure is flexible and the water absorption and holding capability are little affected by bending thereof in, the wick structure can maintain high heat conductivity even if it is long (The conventional copper wick structure has about a Young's modulus of 12,200 kg/mm², and the hydrophilic wick structure according to the present invention has a Young's modulus of about 100 to 3000 kg/mm²).

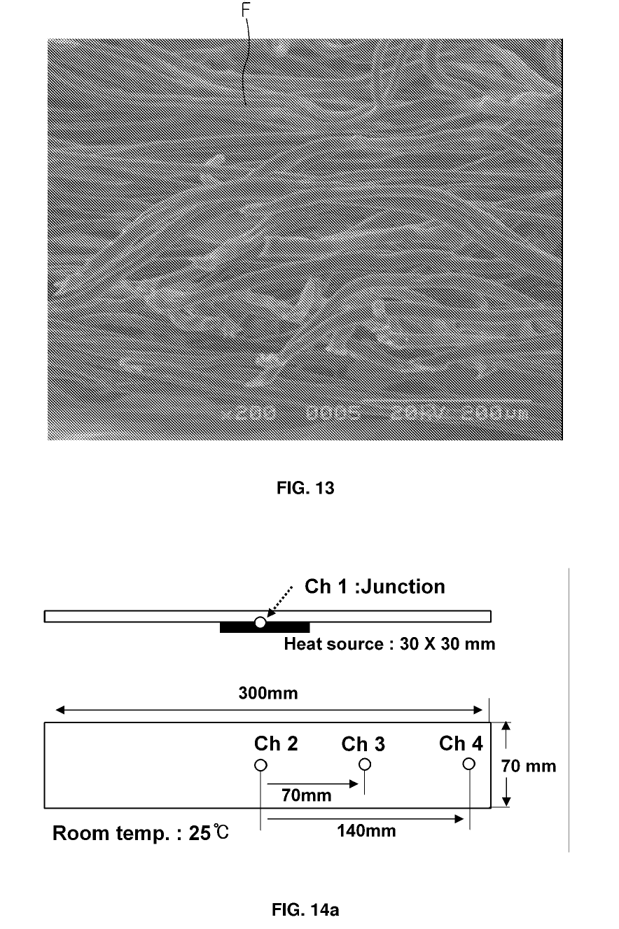

FIG. 13 is an enlarged view illustrating the hydrophilic wick structure according to the present invention. As shown in FIG. 13, the hydrophilic wick structure is an aggregation of fine fibers F, each of the fine fibers F having a hollow in a section thereof. As micro channels are formed between adjacent fibers, capillary force, which is the driving force for moving coolant, is greatly increased. If the wick structure is pressed by a support structure which will be described below, the sizes of gaps formed between the adjacent fibers are reduced, thereby micro channels having a nano level size can be realized, and capillary force is further increased. If the wick structure is wet by water, the wick structure is brought into close contact with the inner surface of a casing. Accordingly, the heat transfer characteristic improves.

Further, the manufacturing cost of the hydrophilic wick structure is lower than that of the conventional screen mesh structure or the conventional thin plate structure having micro channels.

In addition, since the hydrophilic wick structure is much lighter (the conventional copper wick structure: 8.94 g/cc; the hydrophilic wick structure: 0.8 to 2.5 g/cc), a heat transfer device manufactured using the hydrophilic wick structure can also be lighter. Further, electronic components in which the heat transfer device is mounted can have lighter structures.

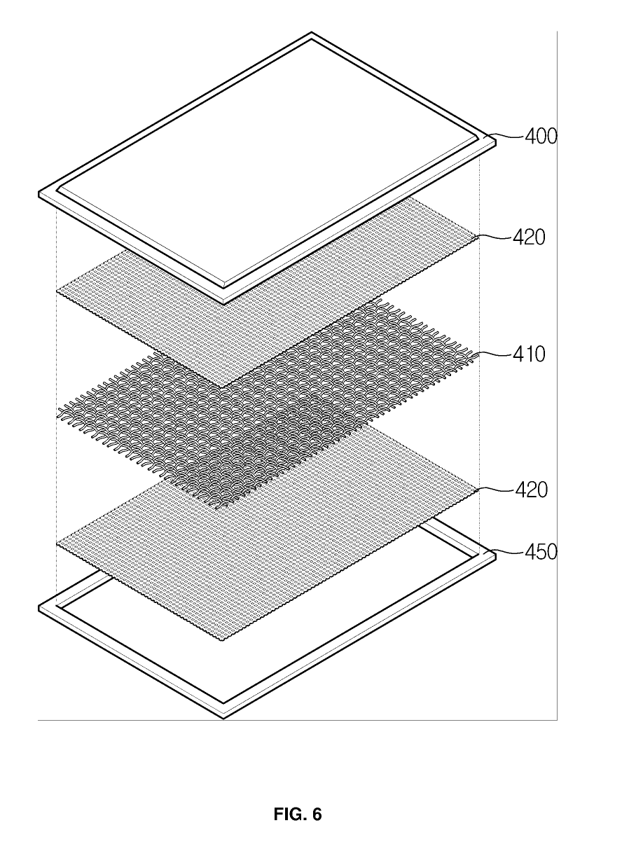

FIG. 6 illustrates a flat panel type heat transfer device using the above described hydrophilic wick structure, according to the first embodiment of the invention. As shown in FIG. 6, the heat transfer device comprises a casing which comprises an upper plate 400 and a lower plate 450, two sheets of hydrophilic wick structures 420 disposed in the casing, and a support structure 410 such as a screen mesh which is also disposed in the casing. The hydrophilic structure is assembled with coolant loaded in the hydrophilic structure to wet the inner surface. In this case, it is not necessary that coolant be additionally injected between the upper plate 400 and the lower plate 450. Accordingly, the assembly process is simplified.

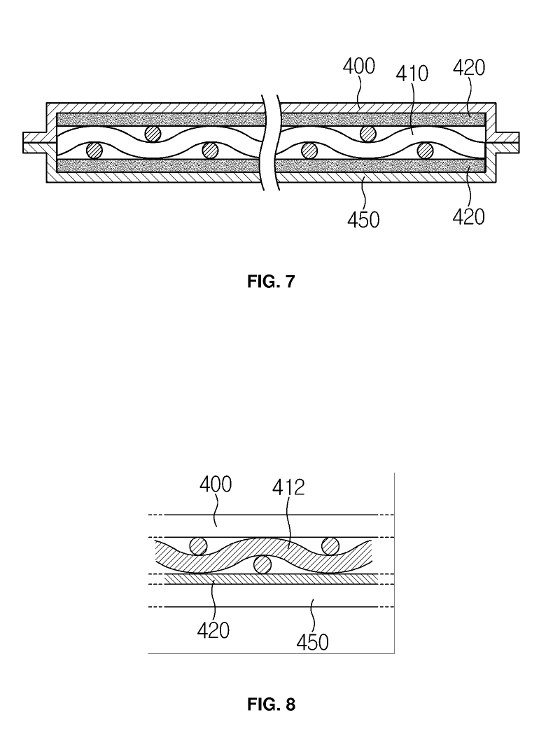

FIG. 7 is a sectional view of the heat transfer device shown in FIG. 6. When the heat transfer device is assembled, the support structure 410 brings the respective hydrophilic structures into close contact with the upper plate 420 and the lower plate 450.

FIG. 8 is a sectional view illustrating the heat transfer device according to the second embodiment of the present invention. In the heat transfer device according to the second embodiment, a hydrophilic wick structure 420 is provided only on an upper surface of a lower plate 450. A support structure 412 is disposed to be in contact with the lower surface of an upper plate 400 and the upper surface of the hydrophilic wick structure 420. The support structure 412 presses the hydrophilic wick structure 420 toward the upper surface of the lower plate 450, so that the hydrophilic wick structure 420 is brought into close contact with the upper surface of the lower plate 450. Inside the heat transfer device, hot coolant vapor vaporized by heat from a heat source flows in both the vertical direction and the horizontal direction of the upper plate 400 through the support structure 412, condenses to the liquid phase at a low temperature point, and flows back to the hydrophilic wick structure 420 to evaporate again, thereby completing the cycle.

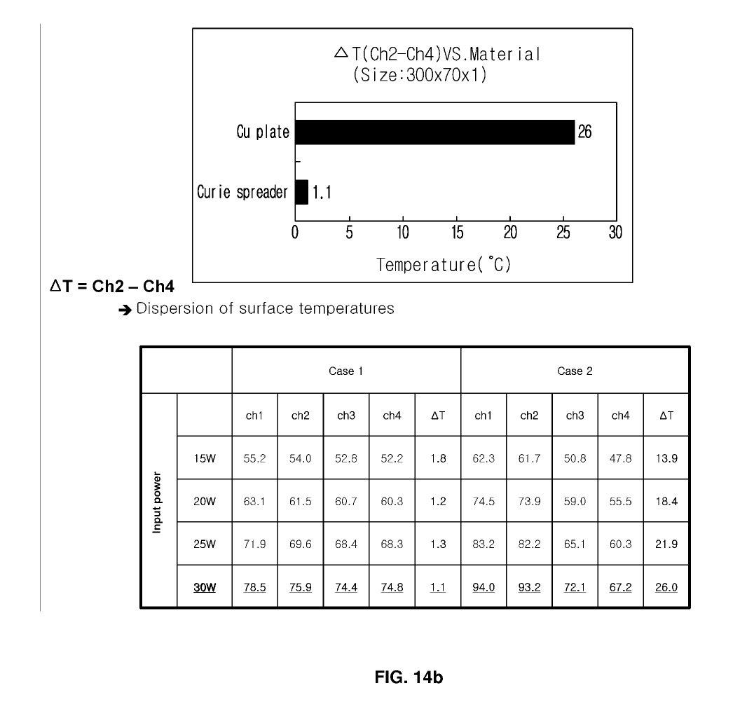

FIGS. 14a and 14b illustrate the results of performance tests between heat transfer devices using the hydrophilic wick structures. As shown in FIG. 14a, heat transfer performances of the heat transfer device (300 mm×70 mm×1 mm) according to one embodiment of the present invention with a conventional copper plate (300 mm×70 mm×1 mm) are compared. In this test, the heat source has a size of 30 mm×30 mm, and temperatures of the heat source devices are measured at a point Ch1 directly in contact with the heat source, a point Ch2 which is opposite the point Ch1, a point Ch3 spaced from the heat source by 70 mm, and a point Ch4 spaced from the heat source by 140 mm. As a result, as shown in FIG. 14b, the heat transfer device according to the present invention has relatively high heat transfer capability with respect to the copper plate.

Further, as the hydrophilic wick structure has higher water absorption and holding capability, the heat transfer device to which the hydrophilic wick structure is applied has more excellent heat transfer characteristics. The hydrophilic wick structure preferably absorbs water in an amount of 0.5 to 10 times its total weight.

The hydrophilic wick structure according to the present invention is an aggregation of fibers having water absorbing and holding capabilities. The aggregation of fibers is preferably pulp, paper, fabric or non-woven fabric. The fibers are preferably natural fibers such as cellulose, synthetic fiber, or carbon nanotubes.

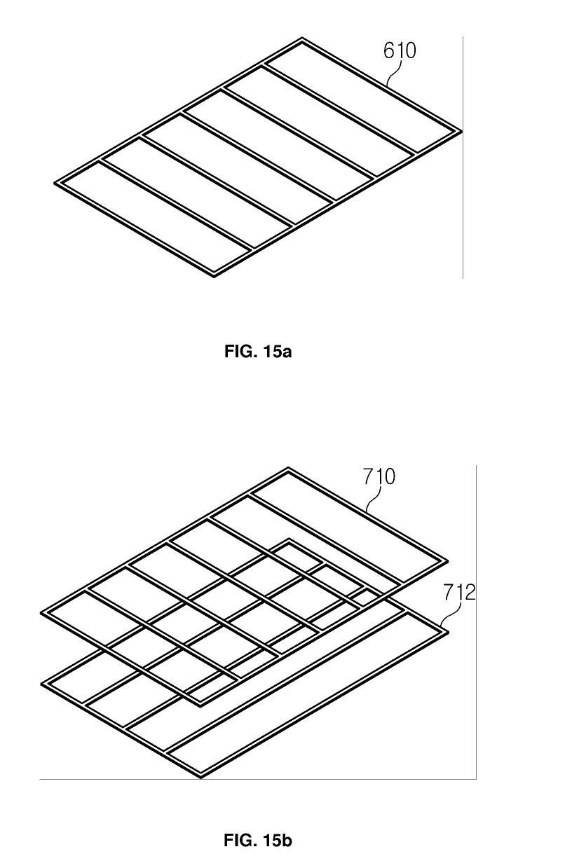

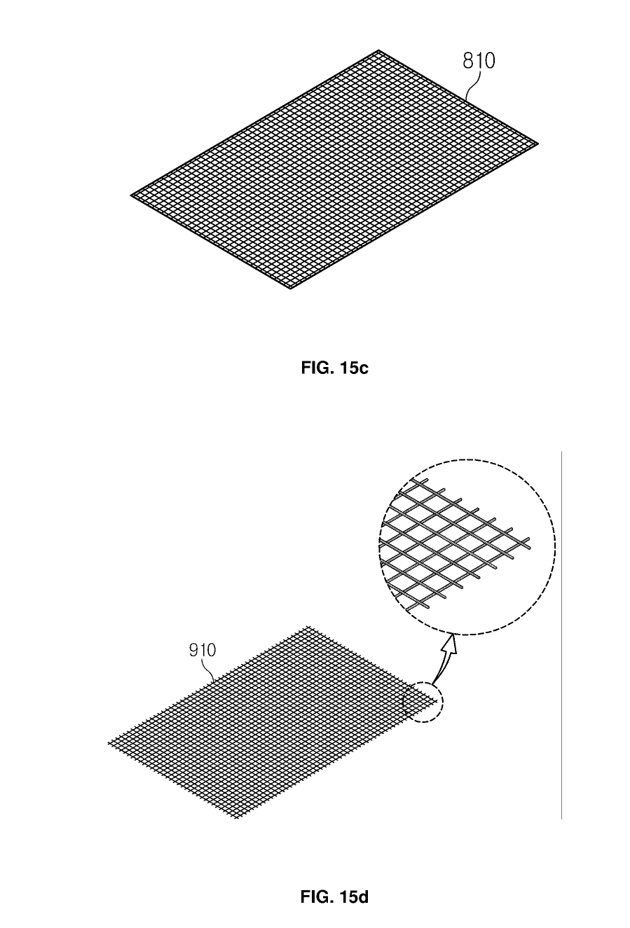

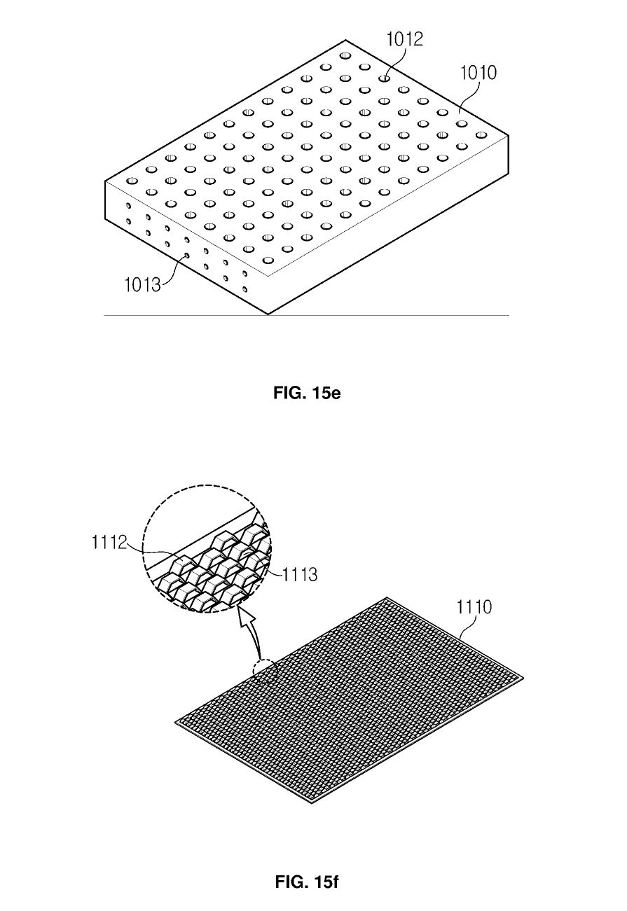

FIGS. 15a to 15f illustrate examples of support structures.

FIG. 15a illustrates a support structure 610 having parallel straight line patterns. FIG. 15b illustrates two sheets of support structures 710 and 712, in which the support structure 710 has parallel line patterns oriented in a first lateral direction and the support structure 712 has parallel line patterns oriented in a second direction which is perpendicular to the first direction.

FIG. 15c illustrates a support structure 810 comprising a frame and a mesh screen structure. FIG. 15 illustrates a support structure having a mesh screen structure without a frame, in which the mesh screen structure is structured such that wires in a first layer extend parallel to each other in a first direction and wires in a second layer extend parallel to each other in a second direction perpendicular to the first direction.

FIG. 15e illustrates a support structure 1010 which is a porous structure formed such that vertical through holes 1012 and horizontal through holes 1013 are formed in a plate. In the case using this structure, vapor generated by a heat source flows in a vertical direction through the vertical through holes 1012, and liquid coolant flows through the horizontal through holes 1013. That is, passages for coolant in a vapor phase and a liquid phase are separately provided. Each of the vertical through holes serving as a vapor passage has a diameter from 0.5 to 4 millimeters, and each of the horizontal through holes serving as a liquid coolant passage has a diameter from 10 to 300 micrometers. The vertical through holes preferably have a relatively large diameter in order to prevent clogging of the vapor passage by the coolant.

FIG. 15f illustrates a support structure 1110 having embossing patterns on a flat plate. As shown in FIG. 15f, each embossing pattern comprises a trapezoidal protrusion 1112 for forming a horizontal vapor passage between the upper plate, while being pressed by the upper plate, and a through hole 1113 formed through the trapezoidal protrusion for providing a vapor passage.

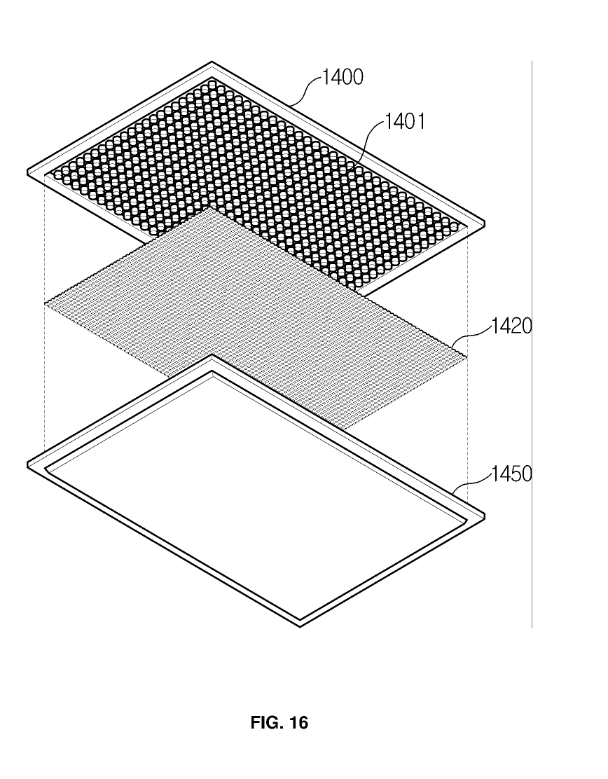

FIG. 16 illustrates a flat panel type heat transfer device according to the third embodiment of the present invention. The hydrophilic wick structure is the same as that of the heat transfer device according to the second embodiment, in that it is in close contact with the upper surface of the lower plate 1450, but is different in that an additional support structure is not used. That is, a plurality of protrusions 1401 formed on the lower surface of the upper plate 1400 serves as the support structure to support the hydrophilic structure 1420 to be in close contact with the upper surface of the lower plate. The protrusion may have a variety of shapes, and coolant in the vapor phase and the liquid phase flows and circulates through the gaps formed between the protrusions.

The heat transfer device according to this embodiment may further include fine grooves on an upper surface of the lower plate with which the hydrophilic wick structure is in close contact. In the case that the lower plate has the fine grooves on its upper surface, since the coolant can flow along the fine grooves as well as through the hydrophilic wick structure having capillary force, a heat transfer device having relatively high reliability can be realized.

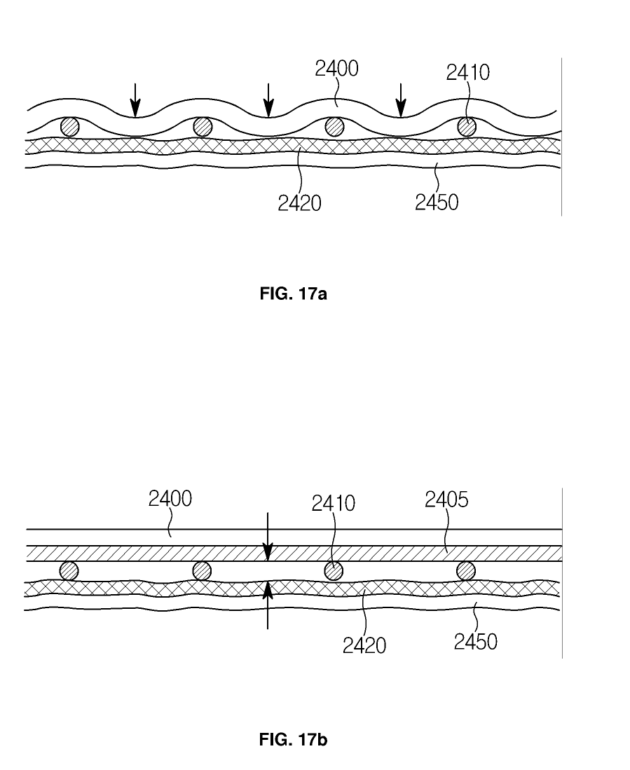

FIGS. 17a and 17b illustrate a heat transfer device according to the fifth embodiment of the present invention. In the flat panel type heat transfer device, an upper plate 2400 and a lower plate 2450, together constituting a casing, are made of flexible polymer. The heat transfer device includes the above described hydrophilic wick structure 2420 to provide passages for vapor and liquid coolant, and a support structure 2410 to enable the hydrophilic wick structure 2420 to be in close contact with the upper surface of the lower plate 2450.

In the case of adopting the above described structure, the heat transfer device has high flexibility. Accordingly, the heat transfer device can be used for a heat source having a complex or three-dimensional structure. That is, it has wide applicability. However, since the gap between the upper plate and the lower plate must be maintained at a low pressure, as shown in FIG. 17a, the flexible upper plate 2400 can be brought into close in contact with the through holes of the support structure 2410 by the difference in pressures. Accordingly, the coolant in the vapor phase and in the liquid phase cannot flow smoothly. In order to prevent this from happening, as shown in FIG. 17b, a reinforcement plate 2405 can be inserted between the upper plate 2400 and the support structure 2410. The reinforcement plate 2405 may be a thin plate made of polymer or metal.

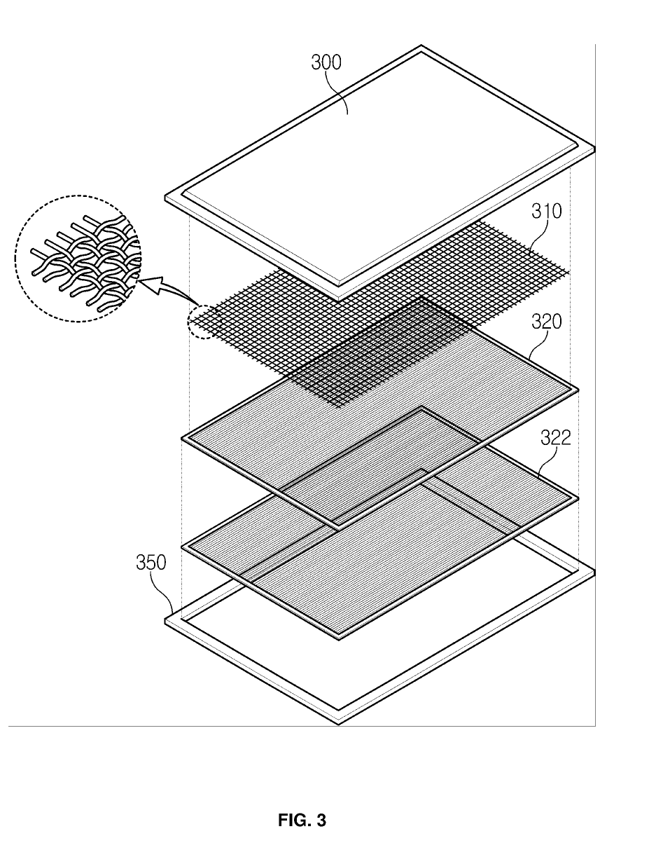

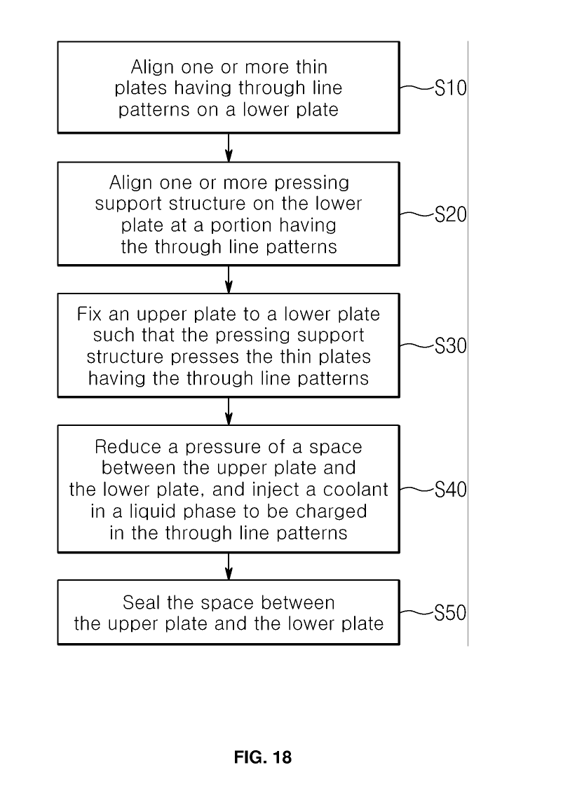

FIG. 18 illustrate a flow chart showing a method of manufacturing the conventional flat panel type heat transfer device shown in FIG. 3.

First, one or more thin plates 310 and 322, each having a plurality of parallel through patterns, are arranged on the upper surface of a lower plate defined by a frame (S10). Next, one or more support structures 310 are arranged on the thin plates 320 and 322, in particular at a portion to be pressed (S20).

Next, the support structure 310 is combined with the upper plate 300 while pressing the portion of the support structure 310 toward the lower plate 350 (S30). In this instance, as shown in FIG. 3, the frames of the upper plates and lower plates can be combined by a welding method or a clamping method.

Next, a vent hole is formed to reduce the pressure in the space formed between the upper plate 300 and the lower plate 350, and then a portion of the space is filled with coolant (S40). Next, the space is sealed (S50).

The filling method for injecting the coolant into the space between the upper plate 300 and the lower plate 350 is as follows. Air in the space between the upper plate 300 and the lower plate 350 is discharged in order to reduce the pressure in the space, liquid coolant is injected into the space, and the space is sealed. Alternatively, the space between the upper plate 300 and the lower plate 350 is filled with coolant, and a small amount of the coolant is extracted from the space in order to reduce the pressure of the space.

However, in the case of manufacturing a flat panel type heat transfer device using a hydrophilic wick structure, according to the present invention, step S20 is not necessary. Reducing the pressure in the space and injecting the coolant into the space are achieved by conventional methods, or alternatively by the following method in taking advantage of high water holding capability of the hydrophilic wick structure.

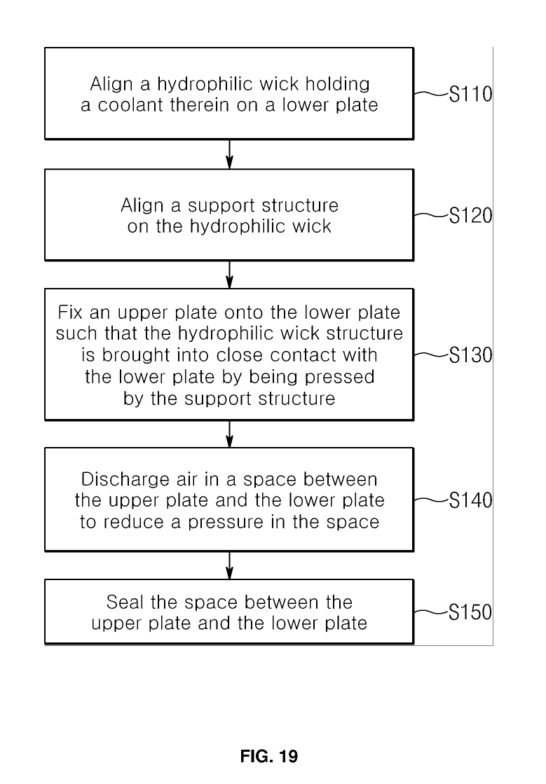

FIG. 19 is a flowchart showing a method for manufacturing a flat panel type heat transfer device using the hydrophilic wick structure. A hydrophilic wick, wet with coolant, is placed on a lower plate (S110), a support structure is aligned therewith (S120), and an upper plate is combined with the lower plate such that the hydrophilic wick is brought into close contact with the lower plate by the support structure.

Next, air in the space between the upper plate and the lower plate is discharged out in order to reduce the pressure in the space (S140), and then the space between the upper plate and the lower plate is sealed (S150). Since the hydrophilic wick structure has water absorption and holding characteristics, the heat transfer device can be manufactured without an additional coolant injection process. Accordingly, the manufacturing method is simplified.

The flat panel type heat transfer device and the method of manufacturing the same according to the present invention can be diversely modified and applied, and are not limited to the above described embodiments. For example, the heat transfer device may have a rectangular shape as illustrated in the embodiments and also may have a polygonal shape or a freeform curved shape. Further, the number of hydrophilic wick structures and support structures can be higher than that in the embodiments.

Although preferred embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

According to the present invention, provided are a flat panel type heat transfer device and a method for manufacturing the same, the heat transfer device being capable of ensuring high heat transfer capability and being manufactured at low cost.

Further, since inner elements of the heat transfer device are made of a material that is capable of absorbing water, the coolant passage can be prevented from drying out.

In addition, the method for manufacturing the heat transfer device is simple and has a low defect rate, so that the heat transfer device can be manufactured at high productivity and low cost when it is manufactured at the mass production volumes.

The heat transfer device has high coolant supply capability due to the high capillary force thereof, and has high reliability since it is little affected by process errors.

The heat transfer device using the above described hydrophilic wick structure has high flexibility and the high reliability, so that it is expected that its application range becomes wider.

1. A flat panel type heat transfer device effectively dissipating heat generated from a heat source in contact with a casing, comprising:
the casing sealed and having a certain shape;
a coolant loaded in the casing and undergoing phase transition;
one or more flat panel type hydrophilic wick structures in contact with at least a portion of an inner surface of the casing, being manufactured by aggregating fibers capable of absorbing the coolant, and providing a coolant passage leading the coolant to flow in a direction parallel to the inner surface of the casing; and
one or more support structures, each having a plurality of through holes which provide coolant passages through which a coolant in a vapor phase or a liquid phase flows, while supporting the hydrophilic wick structure such that the hydrophilic wick structure is in close contact with the inner surface of the casing,
wherein the coolant fills a portion of a space in the casing and circulates in the space in a manner such that the coolant flows in the liquid phase through the hydrophilic wick structure by means of capillary force generated in fine passages formed in the hydrophilic wick structure toward a relatively hot point, is evaporated by heat from a heat source at the hot point, flows in a vapor phase to a relatively low temperature point, condenses at the relatively low temperature point, flows back to the hot point in the liquid phase again, and repeats the cycle of evaporation and condensation.

2. The flat panel type heat transfer device as claimed in claim 1, wherein the casing comprises an upper plate and a lower plate, the support structure being in contact with an inner surface of the upper plate, and the hydrophilic wick structures being interposed between the upper plate and the lower plate.

3. The flat panel type heat transfer device as claimed in claim 2, further comprising one or more hydrophilic wick structures disposed between the upper plate and the support structure, and in contact with an inner surface of the upper plate.

4. The flat panel type heat transfer device as claimed in claim 1, wherein a molecular structure of the fiber includes one or more hydrophilic groups selected from the group consisting of —OH, —COOH, ═O, —NH2, —NH— and ═N—, the hydrophilic group being capable of easily bonding to water.

5. The flat panel type heat transfer device as claimed in claim 1, wherein the surface of the fiber is chemically treated to have hydrophilic characteristics, thereby having a capability to absorb water.

6. The flat panel type heat transfer device as claimed in claim 1, wherein the fiber has a non-circular shape, and a capability to hold water therein.

7. The flat panel type heat transfer device as claimed in claim 1, wherein the fiber has one or more hollows therein.

8. The flat panel type heat transfer device as claimed in claim 1, wherein the fiber has fine scratches or grooves on a surface thereof, or the surface of the fiber is treated to have roughness.

9. The flat panel type heat transfer device as claimed in claim 1, wherein the fiber is a natural fiber, a synthetic fiber or an inorganic fiber.

10. The flat panel type heat transfer device as claimed in claim 1, wherein the fiber is a carbon nanotube.

11. The flat panel type heat transfer device as claimed in claim 1, wherein the hydrophilic wick structure is able to absorb water in an amount of 0.5 times a weight thereof.

12. The flat panel type heat transfer device as claimed in claim 1, wherein the hydrophilic wick structure provides capillary force that can move coolant via micro channels formed between the fibers.

13. The flat panel type heat transfer device as claimed in claim 1, wherein the fibers have a diameter of 1.0 millimeters or less, and the hydrophilic wick structure has a thickness of 5.0 millimeters or less.

14. The flat panel type heat transfer device as claimed in claim 1, wherein the support structure is a porous structure having vertical through holes and horizontal through holes in order to enable the coolant in a vapor phase move in a vertical direction and to enable the coolant in a liquid phase to move in a horizontal direction.

15. The flat panel type heat transfer device as claimed in claim 14, wherein the support structure serves as a thermal insulator for thermally insulating a liquid phase coolant passage, formed by the micro channels in the hydrophilic wick structure disposed under the support structure, from a vapor phase coolant passage disposed above the support structure.

16. The flat panel type heat transfer device as claimed in claim 14, wherein each of the vertical through holes serving as a vapor phase coolant passage has a diameter from 0.5 to 4 millimeters, each of the horizontal through holes serving as a liquid phase coolant passage has a diameter of 10 to 300 micrometers, and the support structure has a thickness of 1 millimeters or less.

17. The flat panel type heat transfer device as claimed in claim 1, wherein the support structure has embossed patterns on a flat plate, the embossed pattern having a trapezoidal shape and a through hole formed to pass through a cross section of the trapezoidal embossed pattern.

18. The flat panel type heat transfer device as claimed in claim 1, wherein the support structure is a screen mesh having a mesh number of 50 or less based on E-11-95 of an ASTM standard.

19. The flat panel type heat transfer device as claimed in claim 18, wherein the screen mesh is made of metal, polymer, silicon or ceramic.

20. The flat panel type heat transfer device as claimed in claim 1, wherein the casing comprises an upper plate and a lower plate, both plates being made of metal, polymer, silicon or nonferrous metal.

21. The flat panel type heat transfer device as claimed in claim 20, wherein a surface of the casing is coated with polymer.

22. The flat panel type heat transfer device as claimed in claim 1, wherein the casing has a plurality of grooves serving as coolant passages on an inner surface thereof.

23. The flat panel type heat transfer device as claimed in claim 1, wherein the thickness of the heat transfer device is 1.0 millimeters or less.

24. The flat panel type heat transfer device as claimed in claim 1, wherein the casing is made of a flexible polymer, and the heat transfer device further comprises a thin plate disposed between the support structure and an inner surface of the casing in order to prevent the inner surface of the casing from blocking an entrance of a through hole of the support structure.

25. The flat panel type heat transfer device as claimed in claim 24, further comprising a thin plate disposed between the hydrophilic wick structure and the inner surface of the casing, in order to prevent the hydrophilic wick structure from blocking an entrance of the through hole of the support structure when air in the casing is discharged.

26. A flat panel type heat transfer device for effectively dissipating heat generated from a heat source in contact with an outer surface of a casing, comprising:
the casing sealed and having a predetermined shape;
coolant injected in the casing and undergoing phase transition;
one or more hydrophilic wick structures in contact with a portion of an inner surface of the casing, manufactured by aggregating fibers, in which the fibers have a structure being able to absorb the coolant therein, and providing a coolant passage parallel to an inner surface of the casing; and
a plurality of protrusions formed on the inner surface of the casing in order to provide support such that the hydrophilic wick structure is in contact with an opposite inner surface of the casing, and in order to provide a liquid phase coolant passage and a vapor phase coolant passage therebetween,
wherein the coolant fills a portion of a space in the casing, flows through the hydrophilic wick structure by means of capillary force generated in fine channels in the hydrophilic wick structure, and circulates in the space in a manner such that the coolant is evaporated by a heat source, changes into a vapor phase, condenses at a relatively low temperature point and changes into a liquid phase, thereby performing heat transfer.

27. The flat panel type heat transfer device as claimed in claim 26, wherein the protrusions are formed by means of etching or mechanical machining of the inner surface of the casing.

28. The flat panel type heat transfer device as claimed in claim 26, wherein the protrusions have a cylindrical shape or a polygonal pillar shape, and a distance between the protrusions is from about 0.2 to about 20 millimeters.

29. A chip set comprising:
the flat panel type heat transfer device as claimed in claim 1; and
one or more semiconductor chips in contact with the flat panel type heat transfer device.

30. A chip set comprising:
the flat panel type heat transfer device as claimed in claim 26; and
one or more semiconductor chips in contact with the flat panel type heat transfer device.

31. A method of manufacturing a heat transfer device, comprising:
aligning a hydrophilic wick structure containing coolant therein on a lower plate;
aligning a support structure on the hydrophilic wick structure;
combining an upper plate and the lower plate such that the hydrophilic wick structure is maintained in close contact with the lower plate by the support structure;
discharging air to reduce pressure of a space between the upper plate and the lower plate; and
sealing the space between the upper plate and the lower plate.
